(19) United States
(12) Patent Application Publication
(10) Pub. No.: US 2008/0278768 A1
(43) Pub. Date: Nov. 13, 2008

(54) Apparatus, Method and Software for Printing Diagnostic Images

(75) Inventor: Henricus Hubert Jozef Peusens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,904

(22) PCT Filed: Jun. 22, 2005
(86) PCT No.: PCT/IB2005/052038

§ 371 Date: Dec. 19, 2006

(30) Foreign Application Priority Data
Jun. 29, 2004 (EP) 04103039.6

(51) Int. Cl. H04N 1/387

(52) U.S. Cl. 358/302

(57) ABSTRACT

The invention relates to an apparatus for printing diagnostic images in a predefined sequence and a format corresponding to a sheet of film, embodied with or linkable to a data-source of the images, wherein the images are preceded by a header carrying information specifying the number and sort of images to be printed, including text images, with a counter for establishing a number of filmports to be used in dependence of at least the information in the header, wherein each image to be printed corresponds to one filmport, and with a scaling organ for adapting the size of said filmports to cover the format so as to maximise the used area thereof.

The invention relates to a method and an apparatus for printing diagnostic images in a predefined sequence and a format corresponding to a sheet of film, embodied with or linkable to a data-source of the images, wherein the images are preceded by a header carrying information specifying the number and sort of images, including text images.

Such an apparatus and method is known from U.S. Pat. No. 5,777,753.

The known method and apparatus is utilised for maximising the number of digital radiological images displayed on a single sheet of film. To this end the images are processed in order to identify frames, within the boundaries of which the diagnostic information is provided. The information of the images outside of the frames are considered redundant and deleted and the resulting modified images with diagnostic information are arranged relative to one another in an area corresponding to the area of the sheet of film and subsequently printed thereon.

The invention is aimed at optimising the effective use of film without deleting information from the available diagnostic images that are to be provided on said film.

Another object of the invention is to reduce film usage and yet print the images into filmports that provide effective visual diagnostic possibilities.

The method of the invention operates on images that are preceded by a header carrying information specifying the number and sort of images to be printed, including text images, and is characterized by calculating a number of filmports to be used depending on at least the information in the header, wherein each image to be printed corresponds to one filmport, and scaling said filmports to cover the format so as to maximise the used area thereof.

Consistent therewith the apparatus of the invention is characterized by a counter for establishing a number of filmports to be used in dependence of at least the information in the header, wherein each image to be printed corresponds to one filmport, and a scaling organ for adapting the size of said filmports to cover the format so as to maximise the used area thereof.

In order to meet the requirements for effective diagnostic analysis it is preferred that the scaling organ is arranged to adapt the size of each filmport in a series of filmports alike.

Advantageously the scaling organ is arranged to operate in dependency of a predefined parameter-value representing a maximum number of filmports to cover the format. By this feature it is possible to operate the apparatus in dependence of the requirements of a physician by simply inputting the desired maximum number of filmports to be shown in one sheet of film. Such filmports may relate to pictorial images but also to text images. Furthermore, the filmports may relate to plan scan images providing an overview of the region of interest of a patient being under examination, and a suitable selection may be made by the physician whether or not certain images may be skipped from the sequence to be printed on the sheet of film.

The apparatus of the invention is suitably organised such that the scaling organ is arranged to operate in dependency of a predefined conversion-table for converting the number of filmports to be used into a matrix of rows and columns of said filmports to be used for covering the format. In this way preferred ways of presenting the images on the sheet of film may be provided allowing for effective diagnosis by the physician.

The invention is also embodied in software for working in conjunction with an apparatus for printing diagnostic images in a predefined sequence and a format corresponding to a sheet of film as discussed here-above.

The software according to the invention is characterized by a first algorithm for establishing a number of filmports to be used in dependence of at least the information in the header, wherein each image to be printed corresponds to one filmport, and a second algorithm for adapting the size of said filmports to cover the format so as to maximise the used area thereof.

Further preferred embodiments of the software are specified in dependent claims 7-9.

The invention will now further be elucidated with reference to a non-limiting example of a preferred embodiment with reference to the drawing. In the drawing:

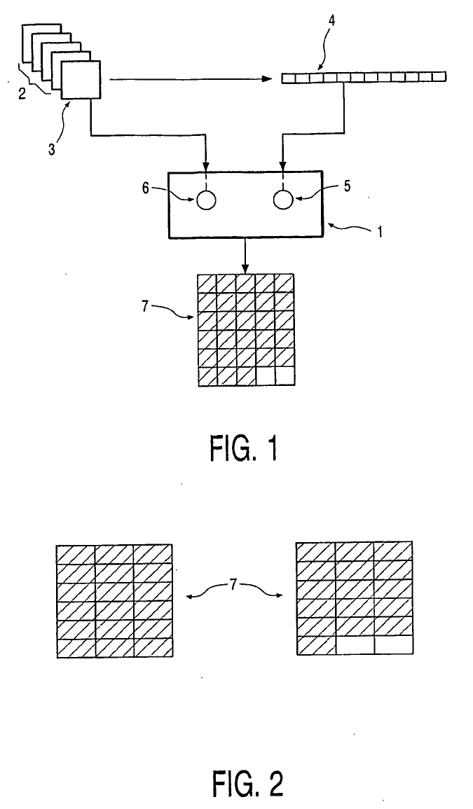

FIG. 1 relates to a schematic diagram showing features of the apparatus according to the invention and its method of working;

FIG. 2 shows an example of 28 images printed in accordance with the invention on two filmsheets;

Table 1 shows a conversion table for a maximum number of thirty filmports in portrait lay-out, and

Table 2 shows a conversion table for a maximum number of twenty-five filmports also in portrait lay-out.

With reference now first to FIG. 1 reference numeral 1 denotes the apparatus according to the invention for printing diagnostic images in a predefined sequence and a format corresponding to a sheet of film.

The diagnostic images are schematically indicated and denoted by reference numeral 2 and preceded by a header 3 carrying (digital) information specifying the number and sort of images, including text images, and the number of plan scan images providing an overview of a scanned region which is to be diagnosed. This is schematically indicated by the repeatedly shown information header denoted by reference numeral 4.

The apparatus of the invention which may be a computer-based workstation, includes a counter 5 which is capable to read out the information header 4 for establishing the number of filmports which are to be used in printing the diagnostic images on a sheet or sheets of film 7. For this purpose the counter 5 reads out the information header 4 and determines the number of picture images to be printed and whether or not specific images therefrom are to be skipped. Furthermore, the counter 5 takes into account the number of plan scan images to be provided on the sheet of film and, if available, the number of text images.

The number of filmports to be used, in this example twenty-eight filmports, are provided to a scaling organ 6 of the apparatus 1 which adapts the size of these filmports so as to cover the format of the sheet of film in order to maximise the actually used area thereof. This way the amount of unused film is reduced and the amount of detailing in the images provided on the film 7 is optimised.

Film 7 is subdivided into a pre-defined maximum number of filmports that may be used to cover the format of the film. In this example the division is done into a maximum number of 30 filmports divided into six rows of five columns.

FIG. 2 shows the situation when the same twenty-eight filmports would have to be divided over two filmsheets, each allowing for a maximum number of twenty-five usable filmports. In that case each filmsheet would carry fifteen filmports divided into five rows of three columns, as will be explained hereinafter.

In connection with the diagnostic purpose it is preferred that the scaling organ 6 adopts the size of each of the twenty-eight filmports that are to be printed on the film mutually alike. This promotes the comparability of each of the filmports from the series of filmports.

FIG. 1 and FIG. 2 show that in this example wherein twenty-eight filmports are to be printed two filmports remain unused whilst the actual use of the available film area is optimised.

Tables 1 and 2 each concern conversion tables that the scaling organ 6 utilises for converting the number of filmports to be used into a matrix of rows and columns of said filmports to actually cover the format of the film. Table 1 allows for a maximum number of thirty filmports to be printed on one filmsheet, whereas Table 2 allows for a maximum number of twenty-five filmports.

Table 1 shows in the first column the desired number of required filmports as calculated with the counter 5 of the apparatus 1 for printing diagnostic images.

TABLE 1

| # of req. | Film format | Total # of | Unused | Film lost |
|---|---|---|---|---|
| filmports | (max = 30) | filmports | filmports | (max = 30)[%] |
| 1 | 1cx1r | 1 | 0 | 0.00 |
| 2 | 1cr2r | 2 | 0 | 0.00 |
| 3 | 2cx2r | 4 | 1 | 25.00 |
| 4 | 2cx2r | 4 | 0 | 0.00 |
| 5 | 2cx3r | 6 | 1 | 16.67 |
| 6 | 2cx3r | 6 | 0 | 0.00 |
| 7 | 3cx3r | 9 | 2 | 22.22 |
| 8 | 3cx3r | 9 | 1 | 11.11 |
| 9 | 3cx3r | 9 | 0 | 0.00 |
| 10 | 3cx4r | 12 | 2 | 16.67 |
| 11 | 3cx4r | 12 | 1 | 8.33 |
| 12 | 3cx4r | 12 | 0 | 0.00 |
| 13 | 3cx5r | 15 | 2 | 13.33 |
| 14 | 3cx5r | 15 | 1 | 6.67 |
| 15 | 3cx5r | 15 | 0 | 0.00 |
| 16 | 4cx4r | 16 | 0 | 0.00 |
| 17 | 4cx5r | 20 | 3 | 15.00 |
| 18 | 4cx5r | 20 | 2 | 10.00 |
| 19 | 4cx5r | 20 | 1 | 5.00 |
| 20 | 4cx5r | 20 | 0 | 0.00 |
| 21 | 4cx6r | 24 | 3 | 12.50 |
| 22 | 4cx6r | 24 | 2 | 8.33 |
| 23 | 4cx6r | 24 | 1 | 4.17 |
| 24 | 4cx6r | 24 | 0 | 0.00 |
| 25 | 5cx5r | 25 | 0 | 0.00 |
| 26 | 5cx6r | 30 | 4 | 13.33 |
| 27 | 5cx6r | 30 | 3 | 10.00 |
| 28 | 5cx6r | 30 | 2 | 6.67 |
| 29 | 5cx6r | 30 | 1 | 3.33 |
| 30 | 5cx6r | 30 | 0 | 0.00 |
| 31 | 2x(4cx4r) | 32 | 1 | 3.13 |
| 32 | 2x(4cx4r) | 32 | 0 | 0.00 |
| 33 | 2x(4cx5r) | 40 | 7 | 17.50 |
| 34 | 2x(4cx5r) | 40 | 6 | 15.00 |
| 35 | 2x(4cx5r) | 40 | 5 | 12.50 |
| 36 | 2x(4cx5r) | 40 | 4 | 10.00 |
| 37 | 2x(4cx5r) | 40 | 3 | 7.50 |
| 38 | 2x(4cx5r) | 40 | 2 | 5.00 |

The second column of table 1 shows the possible combinations of numbers of columns and rows (in portrait lay-out; landscape lay-out is however possible too) that may be used for printing the number of desired filmports. In this example wherein twenty-eight filmports have to be printed, the maximum number of columns is five and the maximum number of rows is six, corresponding to a maximum number of thirty filmports to cover one film format.

The third column of table 1 shows the number of available film ports corresponding to the selected number of columns and rows whereas the fourth and fifth column respectively show the number of unused film ports and the percentage of unused film.

In the example of FIG. 1 wherein the number of required filmports equals twenty-eight whereas the number of available filmports equals thirty, same results in two unused filmports corresponding to 6.67% of unused film.

Table 2 carries a conversion table corresponding to the conversion table of table 1, with the difference however that the maximum number of filmports to be printed on one film sheet equates twenty-five rather than thirty as is the case in table 1.

TABLE 2

| # of req. | Film format | Total # of | Unused | Film lost |
|---|---|---|---|---|
| filmports | (max = 30) | filmports | filmports | (max = 30)[%] |
| 1 | 1cx1r | 1 | 0 | 0.00 |
| 2 | 1cr2r | 2 | 0 | 0.00 |
| 3 | 2cx2r | 4 | 1 | 25.00 |
| 4 | 2cx2r | 4 | 0 | 0.00 |
| 5 | 2cx3r | 6 | 1 | 16.67 |
| 6 | 2cx3r | 6 | 0 | 0.00 |
| 7 | 3cx3r | 9 | 2 | 22.22 |
| 8 | 3cx3r | 9 | 1 | 11.11 |
| 9 | 3cx3r | 9 | 0 | 0.00 |
| 10 | 3cx4r | 12 | 2 | 16.67 |
| 11 | 3cx4r | 12 | 1 | 8.33 |
| 12 | 3cx4r | 12 | 0 | 0.00 |
| 13 | 3cx5r | 15 | 2 | 13.33 |
| 14 | 3cx5r | 15 | 1 | 6.67 |
| 15 | 3cx5r | 15 | 0 | 0.00 |
| 16 | 4cx4r | 16 | 0 | 0.00 |
| 17 | 4cx5r | 20 | 3 | 15.00 |
| 18 | 4cx5r | 20 | 2 | 10.00 |
| 19 | 4cx5r | 20 | 1 | 5.00 |
| 20 | 4cx5r | 20 | 0 | 0.00 |
| 21 | 4cx6r | 24 | 3 | 12.50 |
| 22 | 4cx6r | 24 | 2 | 8.33 |
| 23 | 4cx6r | 24 | 1 | 4.17 |
| 24 | 4cx6r | 24 | 0 | 0.00 |
| 25 | 5cx5r | 25 | 0 | 0.00 |
| 26 | 2x(3cx5r) | 30 | 4 | 13.33 |
| 27 | 2x(3cx5r) | 30 | 3 | 10.00 |
| 28 | 2x(3cx5r) | 30 | 2 | 6.67 |
| 29 | 2x(3cx5r) | 30 | 1 | 3.33 |
| 30 | 2x(3cx5r) | 30 | 0 | 0.00 |
| 31 | 2x(4cx5r) | 40 | 9 | 22.50 |
| 32 | 2x(4cx5r) | 40 | 8 | 20.00 |
| 33 | 2x(4cx5r) | 40 | 7 | 17.50 |
| 34 | 2x(4cx5r) | 40 | 6 | 15.00 |
| 35 | 2x(4cx5r) | 40 | 5 | 12.50 |
| 36 | 2x(4cx5r) | 40 | 4 | 10.00 |

When table 2 applies in the situation that twenty-eight filmports have to be printed, two films 7 are required as shown in FIG. 2. In one of the two films all filmports would be effectively used whereas in the other of the two films two filmports would remain unused corresponding again with 6.67% of lost film area.

For any other number of desired filmports to be printed, the tables 1 and 2 show the required use of film for printing those filmports and the unused area of these films.

1. Apparatus for printing diagnostic images in a predefined sequence and a format corresponding to a sheet of film, embodied with or linkable to a data-source of the images, wherein the images are preceded by a header carrying information specifying the number and sort of images to be printed, including text images, characterized by a counter for establishing a number of filmports to be used in dependence of at least the information in the header, wherein each image to be printed corresponds to one filmport, and further characterized by a scaling organ for adapting the size of said filmports to cover the format so as to maximise the used area thereof.

2. Apparatus according to claim 1, characterized in that the scaling organ is arranged to adapt the size of each filmport in a series of filmports alike.

3. Apparatus according to claim 1, characterized in that the scaling organ is arranged to operate in dependency of a predefined parameter-value representing a maximum number of filmports to cover the format.

4. Apparatus according to claim 3, characterized in that the scaling organ is arranged to operate in dependency of a predefined conversion-table for converting the number of filmports to be used into a matrix of rows and columns of said filmports to be used for covering the format.

5. Method for printing diagnostic images in a predefined sequence and a format corresponding to a sheet of film, wherein the images are preceded by a header carrying information specifying the number and sort of images to be printed, including text images, characterized by calculating a number of filmports to be used depending on at least the information in the header, wherein each image to be printed corresponds to one filmport, and scaling said filmports to cover the format so as to maximize the used area thereof.

6. Software for working in conjunction with an apparatus for printing diagnostic images in a predefined sequence and a format corresponding to a sheet of film, wherein the images are preceded by a header carrying information specifying the number and sort of images to be printed, including text images, characterized by a first algorithm for establishing a number of filmports to be used in dependence of at least the information in the header, wherein each image to be printed corresponds to one filmport, and a second algorithm for establishing a number of filmports to be used in dependence of at least the information in the header, wherein each image to be printed corresponds to one filmport, and further characterized by a second algorithm for adapting the size of said filmports to cover the format so as to maximize the used area thereof.

7. Software according to claim 6, characterized in that the second algorithm is arranged to adapt the size of each filmport in a series of filmports alike.

8. Software according to claim 6, characterized in that the second algorithm is arranged to operate in dependency of a predefined parameter-value representing a maximum number of filmports to cover the format.

9. Software according to claim 8, characterized in that the second algorithm is arranged to operate in dependency of a predetermined conversion-table for converting the number of filmports to be used into a matrix of rows and columns of said filmports to be used for covering the format.
